(19) United States
(12) Patent Application Publication
(10) Pub. No.: US 2015/0295474 A1
(43) Pub. Date: Oct. 15, 2015

(54) ELECTRIC MOTOR PROVIDED WITH COOLING STRUCTURE

(71) Applicant: FANUC CORPORATION, Yamanashi (JP)

(72) Inventors: Masahiro Murota, Yamanashi (JP); Toshifumi Muramatsu, Yamanashi (JP)

(21) Appl. No.: 14/682,630

(22) Filed: Apr. 9, 2015

(30) Foreign Application Priority Data
Apr. 11, 2014 (JP) 2014-082336

(51) Int. Cl. H02K 9/197

(52) U.S. Cl. CPC H02K 9/197

(57) ABSTRACT

An electric motor comprising a rotor which is attached to a shaft which is supported between a front and rear housings, a stator which is provided between the front and rear housings and has a winding wound at its inside, and a molded plastic piece which covers the stator and which covers the winding, which electric motor further comprises at least one medium charging hole which makes cooling medium flow in from outside the stator to the internal space and at least one medium discharging hole which makes the cooling medium be discharged from the internal space to outside the stator so as to thereby cool the rotor and stator by the cooling medium.

### BACKGROUND OF THE INVENTION

1. Field of the Invention

The present invention relates to an electric motor provided with a cooling structure.

2. Description of the Related Art

In an electric motor, to realize smaller size and lighter weight while maintaining the output, the cooling performance is important. Part of the electric motor, that is, the stator, is comprised of a stator core and a stator coil which is wound around slots which are provided in the stator core. For structural reasons, since there are gaps at the slots and the stator coil and at the wire bundles of the stator coil, it is possible to run a pressurized fluid to the inside of the electric motor and cool the stator core and the stator coil by the fluid which runs through the gaps.

On the other hand, to improve the cooling performance of an electric motor, the general practice is to cover the stator coil with molded plastic. By covering the stator coil with molded plastic, the gaps between the slots and stator coil or the wire bundles of the stator coil are closed and the stator core and stator coil contact the plastic, so the heat conducting ability is improved. However, by the molded plastic closing the gaps between the slots and stator coil or the wire bundles of the stator coil, the space inside the electric motor is sectioned off. Accordingly, when covering a stator coil with molded plastic, structural consideration becomes necessary to enable pressurized fluid to be run to the inside of the electric motor and cool the electric motor.

Structures have been proposed which further improve the cooling performance by covering the stator coil with molded plastic and making a cooling medium run through the inside of the electric motor. In addition, structures have also been proposed which run a cooling medium between the molded plastic piece and case so as to improve the cooling performance.

For example, Japanese Patent Publication No. 3-198636A proposes a molded motor which covers the stator core in an electric motor with molded plastic at the time of assembly while preventing as much as possible offset of the axes of the different parts and which thereby facilitates assembly. Further, Japanese Patent Publication No. 64-60241A proposes a structure which covers with molded plastic the coil of a stator in an electric motor whose outside and inside are liquid cooled. Furthermore, Japanese Patent Publication No. 2008-167609A proposes a structure which covers a stator coil with molded plastic in an electric motor and uses the molded plastic piece and the case of the electric motor so as to form a channel for the cooling medium.

However, the improvement of the performance of electric motors is causing the amount of heat which is generated by the electric motors to increase. With the techniques which are proposed in Japanese Patent Publication No. 3-198636A, Japanese Patent Publication No. 64-60241A, and Japanese Patent Publication No. 2008-167609A, the improvement in the cooling performance of the electric motors is still not sufficient. To respond to the demands for cooling performance for such improved performance electric motors, a cooling structure which can promise further improvement in the cooling performance is necessary.

### SUMMARY OF THE INVENTION

The present invention has as its object the provision of an electric motor provided with cooling structure which further improves the cooling efficiency of an electric motor in which the stator and windings are covered by molded plastic.

According to the present invention, there is provided an electric motor comprising a rotor which is attached to a shaft which extends bridging a front housing and a rear housing, a stator which is provided between the front housing and rear housing and has a field coil, which generates a rotating magnetic field which makes the rotor rotate, wound around the inner circumferential side, a molded plastic piece which covers the stator and which covers the field coil, and an internal space which is formed at an inside of the molded plastic piece and holds the rotor to be able to rotate, wherein the electric motor further comprises at least one medium charging hole which makes cooling medium flow in from outside the stator to the internal space and at least one medium discharging hole which makes the cooling medium be discharged from the internal space to outside the stator.

### BRIEF DESCRIPTION OF THE DRAWINGS

The present invention will be understood more clearly by referring to the drawings attached below.

FIG. 1 is a cross-sectional view which illustrates a structure of a first embodiment of an electric motor.

FIG. 2 is a cross-sectional view which illustrates a structure of a second embodiment of an electric motor.

FIG. 3 is a cross-sectional view which illustrates a structure of a third embodiment of an electric motor.

FIG. 4 is a cross-sectional view which illustrates a structure of a fourth embodiment of an electric motor.

### DETAILED DESCRIPTION

Below, referring to the drawings, an electric motor provided with a cooling structure according to the present invention will be explained. However, it should be understood that the present invention is not limited to the drawings or the embodiments which are explained below. In the figures, the same component elements are assigned the same reference notations.

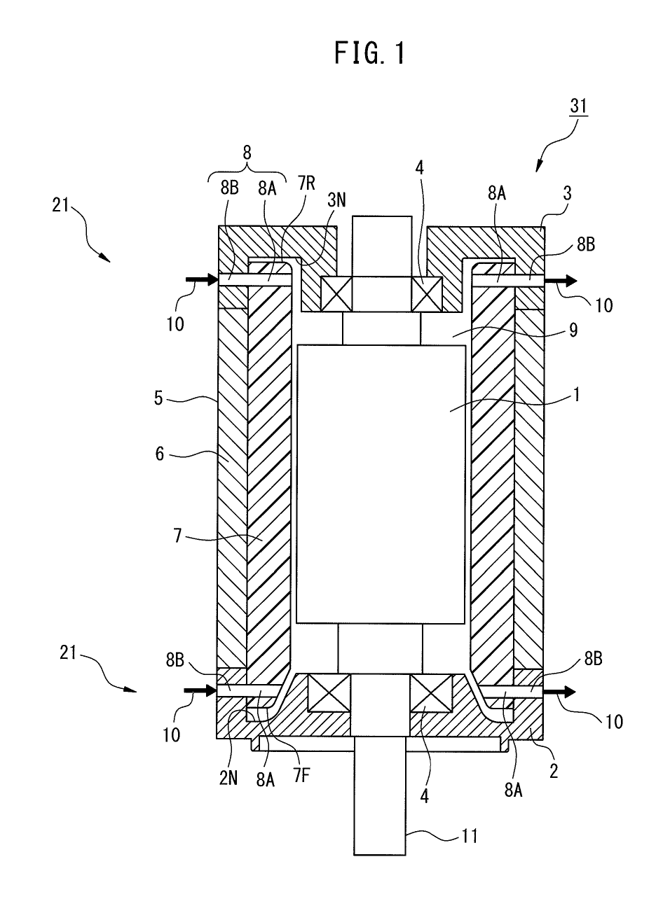

FIG. 1 illustrates by cross-section the structure of an electric motor 31 of a first embodiment. The electric motor 31 of the first embodiment has a front housing 2 and a rear housing 3. The housing of the part which is sandwiched between the front housing 2 and the rear housing 3 is formed by a stator core 6 of a stator 5. A rotor 1 is attached to a shaft 11 which extends bridging the front housing 2 and rear housing 3 and rotates inside of the stator 5. The shaft 11 is supported to be able to rotate by a bearing 4 which is provided at the front housing 2 and a bearing 4 which is provided at the rear housing 3.

The stator 5 is provided with a stator core 6 which also serves as part of the housing of the electric motor 31 and a stator coil (one which generates a rotating magnetic field, also called as “field coil”, not illustrated) which is wound in slots (not illustrated) which are provided at the stator core 6. It has a molded plastic piece 7 which is formed by a plastic material to efficiently dissipate the heat generated from this stator coil. The molded plastic piece 7 covers the stator core 6 and covers the stator coil as well. The front end part of the molded plastic piece 7 reaches the inside circumferential surface of the front housing 2, while the rear end part reaches the inside circumferential surface of the rear housing 3.

In the thus configured electric motor 31, the rotor 1 rotates due to the rotating magnetic field which is generated when energizing the stator coil. Further, by energizing the stator coil, the stator coil generates heat, so the electric motor 31 of the first embodiment is provided with a cooling structure 21. The cooling structure 21 cools by running a cooling medium at the inside 9 of the electric motor between the rotor 1 and the front housing 2 and the inside 9 of the electric motor between the rotor 1 and the rear housing 3. In the electric motor 31 of the first embodiment, the cooling structure 21 is as follows:

The cooling structure 21 which is provided at the electric motor 31 of the first embodiment comprises internal through holes 8A which are provided at the molded plastic piece 7 and external through holes 8B which communicate with the internal through holes 8A through the insides of which the cooling medium 10 flows. A plurality of the internal through holes 8A are provided radially with respect to the shaft 11 at parts of the front end part 7F and rear end part 7R of the molded plastic piece 7 which face the front housing 2 and rear housing 3. Further, the external through holes 8B are provided to communicate with the internal through holes 8A at positions of the front housing 2 and the rear housing 3 which face the internal through holes 8A.

Further, the communicated internal through holes 8A and external through holes 8B form through holes 8 which extend into the electric motor internal space 9. A cooling medium 10 is made to flow through the through holes 8 into the electric motor internal space 9 to cool the electric motor internal space 9, while the heated cooling medium 10 is discharged through the through holes 8 to the outside of the electric motor 31. In this case, half of the through holes 8 may be used as medium charging holes for making the cooling medium 10 flow into the electric motor internal space 9, while the remaining half of the through holes 8 may be used as medium discharging holes for making the cooling medium 10 be exhausted to the outside of the electric motor internal space 9. As the cooling medium 10, a pressurized gas or water or another fluid may be used. That is, the cooling medium 10 used may be either a gas or a liquid so long as being a fluid. The composition is also not limited.

By the cooling medium 10 running through the internal through holes 8A which are provided in the molded plastic piece 7, the area of contact of the molded plastic piece 7 and the cooling medium 10 increases, so the cooling efficiency of the electric motor 31 is improved. By such an improvement of the cooling efficiency of the electric motor 31, the electric motor 31 can be made smaller in size and lighter in weight while maintaining the output of the electric motor 31.

In the electric motor 31 of the first embodiment, the cooling structure 21 was comprised of internal through holes 8A which were provided at the molded plastic piece 7 and external through holes 8B which were provided at positions of the front housing 2 and the rear housing 3 which face the internal through holes 8A so as to communicate with the internal through holes 8A. However, the inflow of cooling medium 10 to the electric motor internal space 9 and the outflow from the electric motor internal space 9 are not limited to this embodiment. For example, the internal through holes 8A may be provided at only one of either the front housing 2 and rear housing 3 as well.

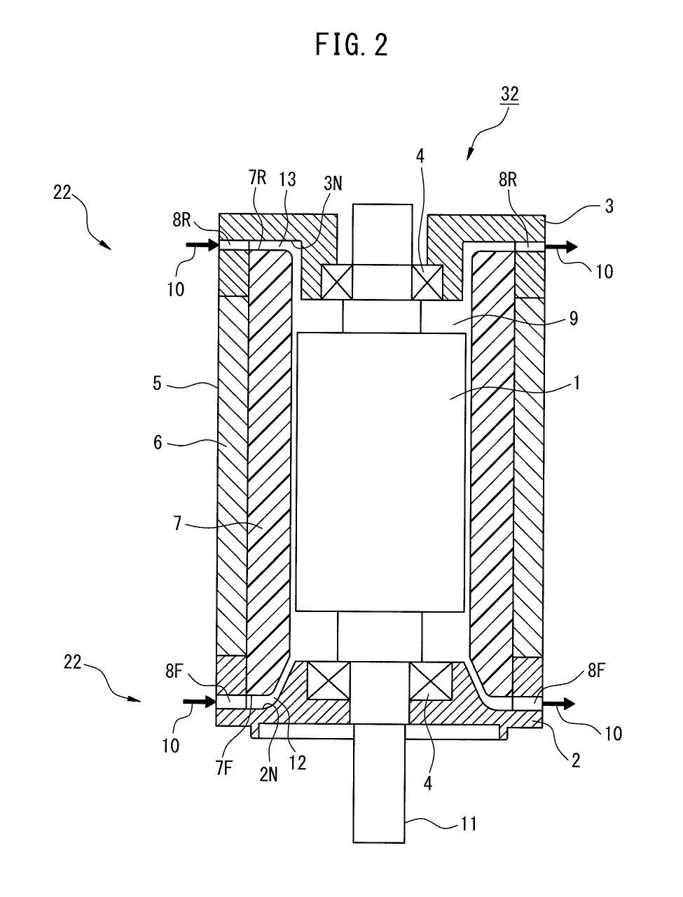

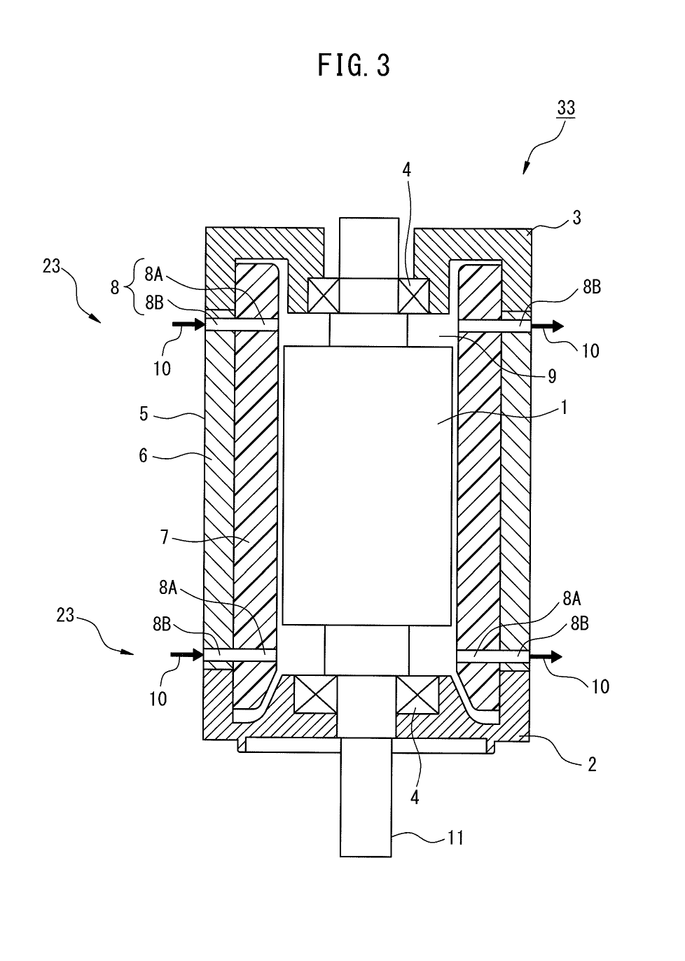

Therefore, a cooling structure 22 which is provided at an electric motor 32 of a second embodiment which is illustrated in FIG. 2 and a cooling structure 22 which is provided at an electric motor 33 of a third embodiment which is illustrated in FIG. 3 will be explained below. Note that, in the electric motors 32 and 33, the rotor 1, front housing 2, rear housing 3, stator 5, and molded plastic piece 7 are the same in shapes as the electric motor 31 of the first embodiment, so these members are assigned the same reference notations and explanations thereof will be omitted.

FIG. 2 illustrates by cross-section the structure of the electric motor 32 of the second embodiment. In the electric motor 32 of the second embodiment, the cooling structure 22 is provided with front side through holes 8F and rear side through holes 8R through the insides of which a cooling medium 10 flows. The front side through holes 8F are provided at the front housing 2 and communicate with the electric motor internal space 9 between the rotor 1 and the front housing 2. In the second embodiment, at least two front side through holes 8F are provided: for use for inflow of the cooling medium 10 into the electric motor internal space 9 and for use for outflow from the electric motor internal space 9. Similarly, at least two rear side through holes 8R are also provided: for use for inflow of cooling medium 10 into the electric motor internal space 9 and for use for outflow from the electric motor internal space 9.

In the electric motor 32 of the second embodiment, the front side through holes 8F are communicated with the gap 12 between the front end part 7F of the molded plastic piece 7 and the inside circumferential surface 2N of the front housing 2, while the rear side through holes 8R are communicated with the gap 13 between the rear end part 7R of the molded plastic piece 7 and the inside circumferential surface 3N of the rear housing 3. The cooling medium 10 which flows from the front side through holes 8F through the gap 12 to the electric motor internal space 9 and the cooling medium 10 which flows from the rear side through holes 8R through the gap 13 to the electric motor internal space 9 pass close to the front end part 7F and rear end part 7R of the molded plastic piece 7. As a result, the area of contact of the molded plastic piece 7 and the cooling medium 10 increases, so the cooling efficiency of the electric motor 32 is improved. Due to such improvement of the cooling efficiency of the electric motor 32, it becomes possible to reduce the size and lighten the weight of the electric motor 32 while maintaining the output of the electric motor 32.

FIG. 3 illustrates by cross-section the structure of the electric motor 33 of the third embodiment. In the electric motor 33 of the third embodiment, the cooling structure 23 is provided with internal through holes 8A and external through holes 8B through the insides of which a cooling medium 10 passes. The internal through holes 8A are provided radially with respect to the shaft 11 at the part of the molded plastic piece 7 which faces the electric motor internal space 9 between the rotor 1 and the front housing 2 and the part which faces the electric motor internal space 9 between the rotor 1 and the rear housing 3. There are at least two internal through holes 8A each for the medium charging holes and medium discharging holes. The external through holes 8B are provided communicating with the internal through holes 8A at positions of the stator 5 which face the internal through holes 8A. Therefore, the number of the external through holes 8B is the same as the number of the internal through holes 8A.

In the third embodiment as well, the internal through holes 8A and the external through holes 8B which communicate with them form through holes 8 which communicate with the electric motor internal space 9. In the cooling structure 23, the cooling medium 10 flows in from at least one of the through holes 8 serving as the medium charging holes to the electric motor internal space 9 and is exhausted to the outside from at least one of the through holes 8 serving as the medium discharging holes. In the cooling structure 23, by the cooling medium 10 running through the internal through holes 8A which are provided in the molded plastic piece 7, the area of contact of the molded plastic piece 7 and the cooling medium 10 increases, so the cooling efficiency of the electric motor 33 is improved. By such an improvement of the cooling efficiency of the electric motor 33, the electric motor 31 can be made smaller in size and lighter in weight while maintaining the output of the electric motor 31.

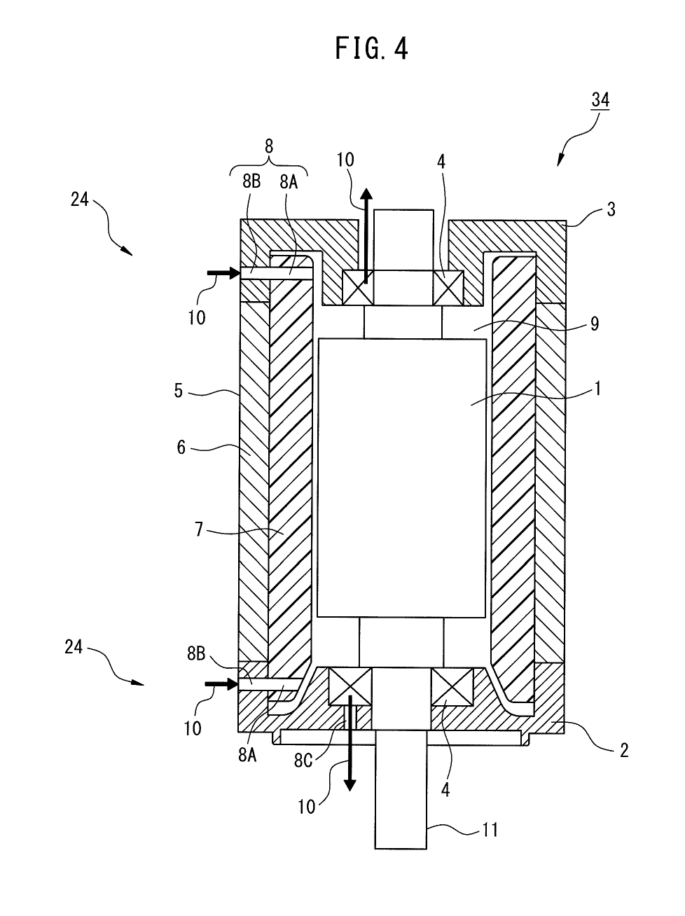

FIG. 4 illustrates by cross-section the structure of an electric motor 34 of a fourth embodiment. In the electric motor 34 of the fourth embodiment, the cooling structure 24 is provided with internal through holes 8A and external through holes 8B through the inside of which a cooling medium 10 passes. The internal through holes 8A are provided radially with respect to the shaft 11 at the part of the molded plastic piece 7 which faces the front housing 2 and the part which faces the rear housing 3. There is at least one internal through hole 8A for the medium charging holes. The external through holes 8B are provided communicating with the internal through holes 8A at positions of the front housing 2 and rear housing 3 which face the internal through holes 8A. Therefore, the number of the external through holes 8B is the same as the number of the internal through holes 8A.

In the fourth embodiment as well, the internal through holes 8A and the external through holes 8B which communicate with them form through holes 8 which communicate with the electric motor internal space 9. In the cooling structure 24, the cooling medium 10 flows in from at least one of the through holes 8 serving as the medium charging holes to the electric motor internal space 9. The cooling medium 10 which flows into the electric motor internal space 9 passes through the gap of the bearing 4 at the rear housing 3 side and is discharged to the outside from between the shaft 11 and the rear housing 3. Therefore, the gap between the shaft 11 and the rear housing 3 becomes the medium discharging hole. Further, if providing at least one auxiliary through hole 8C at the part of the front housing 2 which faces the bearing 4, the cooling medium 10 which flows into the electric motor internal space 9 can pass through the gap of the bearing 4 at the front housing 2 side and be discharged to the outside from the auxiliary through hole 8C.

In the cooling structure 24, by the cooling medium 10 running through the internal through holes 8A which are provided in the molded plastic piece 7, the area of contact of the molded plastic piece 7 and the cooling medium 10 increases, so the cooling efficiency of the electric motor 34 is improved. By such an improvement of the cooling efficiency of the electric motor 34, the electric motor 34 can be made smaller in size and lighter in weight while maintaining the output of the electric motor 34.

As explained above, according to the electric motor provided with a cooling structure of the present invention, it is possible to cover the stator coil and run a cooling medium which cools the molded plastic piece through a through hole so as to make it circulate in the electric motor internal space and thereby cool the molded plastic piece, so it becomes possible to enhance the cooling efficiency of the molded plastic piece. As a result, it becomes possible to realize a smaller size and lighter weight of an electric motor while maintaining the output of the electric motor.

Above, the present invention was explained with reference to preferred embodiments, but a person skilled in the art would understand that various modifications and changes can be made without departing from the scope of the later explained claims.

What is claimed is:

1. An electric motor comprising:
a rotor which is attached to a shaft which extends bridging a front housing and a rear housing;
a stator which is provided between said front housing and rear housing and has a field coil, which generates a rotating magnetic field which makes said rotor rotate, wound around the inner circumferential side;
a molded plastic piece which covers said stator and which covers said field coil;
an internal space which is formed at an inside of said molded plastic piece and holds said rotor to be able to rotate;
at least one medium charging hole which makes cooling medium flow in from outside said stator to said internal space; and
at least one medium discharging hole which makes said cooling medium be discharged from said internal space to outside said stator.

2. The electric motor according to claim 1, wherein
said medium charging holes and said medium discharging holes are comprised of at least two internal through holes which are radially provided from said shaft at parts of said mold which face at least one of said front housing and rear housing and external through holes which are provided to run through said front housing or rear housing and communicate with said internal through holes.

3. The electric motor according to claim 1, wherein
at least one of a location between the inside surface of said front housing and the end face of said molded plastic piece and a location between the inside surface of said rear housing and the end face of said mold is provided with a gap, and
said medium charging holes and said medium discharging holes are said gaps and through hole which are provided at least at one of said front housing and rear housing and communicate with said gaps.

4. The electric motor according to claim 1, wherein said medium charging holes and said medium discharging holes are comprised of at least two internal through holes which are made to pass through said molded plastic piece and are provided radially from said shaft at parts of said molded plastic piece which face said stator and external through holes which are made to pass through said stator and communicate with said internal through holes.

5. The electric motor according to claim 1, wherein said medium charging holes and said medium discharging holes are comprised of internal through holes which are made to pass through said molded plastic piece and are provided radially from said shaft and external through holes which are provided at least at one of said front housing, rear housing, and said stator so as to communicate with said internal through holes.

6. The electric motor according to claim 5 further comprising an auxiliary through hole at a portion of said front housing or said rear housing which faces a bearing of said shaft, said cooling medium which passes through the gap of said bearing being discharged to the outside from said auxiliary through hole.

7. The electric motor according to claim 1, wherein said cooling medium is a fluid.
